(19) United States
(12) Patent Application Publication
(10) Pub. No.: US 2021/0032803 A1
(43) Pub. Date: Feb. 4, 2021

(54) CONDUCTIVE AND FLEXIBLE CARBON FIBER

(71) Applicant: DAINS Co., Ltd,, Jeonju-si (KR)

(72) Inventors: Seung Jeong, Seoul (KR); Young Chul Jin, Jeonju-si (KR); Jung Hoon Yang, Jeonju-si (KR); Woo Young Choi, Busan (KR); Jae-Hwa Kim, Jeonju-si (KR); Chun seong Park, Suwon-si (KR)

(21) Appl. No.: 16/662,414

(22) Filed: Oct. 24, 2019

(30) Foreign Application Priority Data
Jul. 31, 2019 (KR) 10-2019-0093086

(51) Int. Cl. D06M 11/83; D06M 23/00; H01B 1/04

(52) U.S. Cl. CPC D06M 11/83; D06M 2101/40; H01B 1/04; D06M 23/00

(57) ABSTRACT

A conductive and flexible carbon fiber according to the present disclosure includes a carbon fiber; a resin layer formed on the carbon fiber; and a metal plating layer formed on the resin layer. The resin layer of the carbon and flexible carbon fiber according to the present disclosure is uniformly coated on the carbon fiber, such that a breakage of the carbon fiber during the conductive carbon fiber production process may be prevented. In addition, the metal plating layer having the uniform thickness is plated on the resin layer having the uniform thickness, such that the electric conductivity of the carbon fiber may be improved and the flexibility of the carbon fiber may also be increased. In addition, a production process of the carbon and flexible carbon fiber according to the present disclosure is simplified, such that the production cost and time may be saved.

### BACKGROUND

### 1. Field

The present disclosure relates to a conductive and flexible carbon fiber, and in particular, to a conductive and flexible carbon fiber including a metal plating layer and a resin layer.

### 2. Description of Related Art

A carbon fiber material has been rapidly developed together with the development of aerospace industries, and is an advanced material currently used in various fields such as electrical and electronic materials, civil and building materials, automobiles, ships, military equipment, and sporting goods.

However, since the carbon fiber material has no conductivity itself, the carbon fiber material has been very limitedly used for an automobile electronic component and a communication device housing that need to implement both mechanical properties and an electromagnetic wave shielding performance. Therefore, in order to overcome this, a metal coated carbon fiber (MCF) obtained by plating a metal on a carbon fiber is developed. The MCF has both thermal conductivity and electric conductivity of the metal and low thermal expansion properties of the carbon fiber, such that the MCF exhibits excellent physical properties, and the MCF increases an electromagnetic wave shielding efficiency and an electrical disturbance effect due to high electric conductivity. Therefore, the MCF has been highlighted as an advanced material that can be broadly used in electromagnetic wave shielding fields such as an electronic product exterior part and an eco-friendly automobile part, a metal replacement heat radiating fields such as an LED exterior heat radiating plate and a heat radiating material of an electronic device, energy fields such as a gas diffusion layer (GDL) basic material for a fuel cell, an electrode material for a fuel cell separator, and a lighting prevention material of a wind turbine blade, electromagnetic wave shielding cable fields, and bomb material fields for a blackout bomb.

However, since the conductive carbon fiber subjected to the metal plating according to the related art is formed of only a metal plating layer and a carbon fiber, the carbon fiber is easily broken during the metal plating process due to inflexibility, and in a process of imparting conductivity to the carbon fiber, a process of removing the resin layer coated on a surface of the carbon fiber is necessary so as to reduce a resistance value of the carbon fiber. More specifically, the metal plating process of the related art is performed by reducing metal ions in a plating solution through a current flowing between the plating solution in a plating bath and a carbon fiber immersed in the plating solution to precipitate a metal and adsorbing the precipitated metal on a surface of the carbon fiber. In the metal plating process of the related art, in order to flow a current in the carbon fiber, it is required to perform a pretreatment for removing an epoxy resin coated on the surface of the carbon fiber and a sizing agent formed of an insulating resin such as a urethane resin.

In addition, the process of removing the sizing agent (resin) is necessarily performed even in a process for increasing a rigidity of the carbon fiber.

However, the process of removing a resin layer causes complexity and delay in process, and moreover, it is impossible to completely remove the resin layer, uneven resin components thus remain on the surface of the carbon fiber, and the metal plating is performed on the resin layer remaining on the surface of the carbon fiber in the uneven state, such that the metal plating layer is formed in a very uneven state, resulting in reduction of the electromagnetic wave shielding efficiency.

Accordingly, it is required to carry out the research and development on a conductive and flexible carbon fiber capable of ensuring the electromagnetic wave shielding performance by thickness uniformity of a metal plating layer while securing flexibility of the carbon fiber and simplifying a conductive carbon fiber production process.

### RELATED ART DOCUMENT

### Patent Document

(Patent Document 1) Korean Patent Laid-Open Publication No. 10-2016-0000111 (published on Jan. 4, 2016)

(Patent Document 2) Korean Patent Publication No. 10-1968646 (published on Apr. 12, 2019)

### SUMMARY

An object of the present disclosure is to provide a conductive and flexible carbon fiber capable of preventing a breakage of a carbon fiber during a conductive carbon fiber production process, and having an improved electric conductivity and further increased flexibility of the carbon fiber by uniformly maintaining a thickness of a metal plating layer. In addition, another object of the present disclosure is to provide a conductive and flexible carbon fiber capable of saving production cost and time by simplifying a conductive and flexible carbon fiber production process.

According to an exemplary embodiment of the present disclosure, a conductive and flexible carbon fiber includes a carbon fiber; a resin layer formed on the carbon fiber; and a metal plating layer formed on the resin layer.

A thickness of the resin layer may be 10 nm to 1 μm.

The conductive and flexible carbon fiber may further include a bonding layer to increase a bonding force between the resin layer and the metal plating layer.

The bonding layer may be formed on the resin layer by immersing the resin layer in which tin ions (Sn²⁺) are adsorbed in a palladium chloride (PdCl₂) solution or a hydrochloric acid solution, and a concentration of chlorine ions (Cl⁻) in the palladium chloride (PdCl₂) solution or the hydrochloric acid solution may be 13 to 16 mole/l.

The bonding layer may be formed of palladium (Pd).

The resin layer coated on the carbon fiber may be non-conductive and may have a hydrophobic surface.

### BRIEF DESCRIPTION OF DRAWINGS

FIG. 1 illustrates a layer structure of a conductive and flexible carbon fiber according to an exemplary embodiment of the present disclosure.

FIG. 2A is a flowchart illustrating a general production process of a conductive carbon fiber according to the related art.

FIG. 2B illustrates a problem in the production process of the conductive carbon fiber according to the related art.

FIG. 3A is a flowchart illustrating a production process of a conductive and flexible carbon fiber according to the present disclosure.

FIG. 3B illustrates surface evenness of the conductive and flexible carbon fiber according to the present disclosure.

FIGS. 4A and 4B illustrate a process of coating a resin layer in a production of the conductive and flexible carbon fiber according to the present disclosure.

FIGS. 5A to 5C illustrate a process of forming a bonding layer in the production of the conductive and flexible carbon fiber according to the present disclosure.

FIGS. 6A and 6B illustrate a process of forming a first metal plating layer in the production of the conductive and flexible carbon fiber according to the present disclosure.

FIGS. 7A to 7C illustrate a process of forming a second metal plating layer in the production of the conductive and flexible carbon fiber according to the present disclosure.

FIG. 8 illustrates a layer structure of a conductive and flexible carbon fiber according to another exemplary embodiment of the present disclosure.

FIGS. 9A and 9B are photographs obtained by observing a conductive carbon fiber from which a resin layer is removed according to the related art with a microscope.

FIGS. 10A and 10B are photographs obtained by observing a conductive and flexible carbon fiber according to the present disclosure with a microscope.

FIGS. 11A and 11B are photographs obtained by observing a carbon fiber having a resin layer whose thickness is greater than 1 μm with a microscope.

### DETAILED DESCRIPTION

Hereinafter, preferred exemplary embodiments of the present disclosure will be described in detail with reference to the accompanying drawings. The advantages and features of the present disclosure and methods of accomplishing these advantages and features will become obvious with reference to the exemplary embodiments to be described below in detail with reference to the accompanying drawings. However, the present disclosure is not limited to exemplary embodiments to be disclosed below, but various forms different from each other may be implemented. The exemplary embodiments are merely provided to make the present disclosure complete and to completely notify those skilled in the art to which the present disclosure pertains, of the scope of the present disclosure, and the present disclosure is only defined by the scope of the claims. The same reference numerals throughout the specification denote the same elements.

It will be understood that, although the terms “first”, “second”, and the like are used to describe various materials, elements, components, steps and/or sections, these materials, elements, components, steps and/or sections should not be limited by these terms. These terms are only used to distinguish one material, element, component, step and/or section from another material, element, component, step and/or section. Accordingly, a first mixture described below may also be a second mixture within the technical idea of the present disclosure.

Terms used in the present specification are for explaining the exemplary embodiments rather than limiting the present disclosure. Unless explicitly described to the contrary, a singular form includes a plural form in the present specification. The term “comprises” and/or “made of” used in the specification will be understood to imply the inclusion of stated materials, components, steps, operations and/or elements but not the exclusion of any other materials, components, steps, operations and/or elements. Unless otherwise defined, all terms (including technical and scientific terms) used in the specification have the same meaning as commonly understood by those skilled in the art to which the present disclosure pertains. Further, unless defined otherwise, all terms defined in generally used dictionaries may not be overly interpreted.

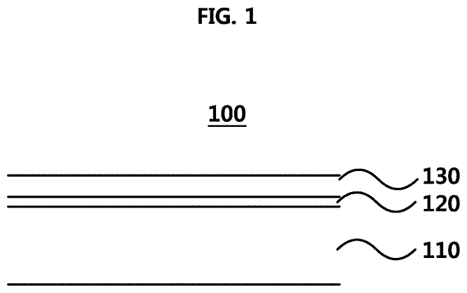

Hereinafter, the present disclosure will be described in detail with reference to the accompanying drawings. FIG. 1 illustrates a layer structure of a conductive and flexible carbon fiber 100 according to the present disclosure. As illustrated in FIG. 1, the conductive and flexible carbon fiber 100 according to the present disclosure includes a carbon fiber 110, a resin layer 120, and a metal plating layer 130.

The carbon fiber 110 is preferably a pure carbon fiber that is not subjected to treatments such as coating, mixing, deforming, and chemical bonding at all.

In the conductive and flexible carbon fiber 100 according to the present disclosure, the resin layer 120 is coated on a surface of the carbon fiber 110. The coating of the resin layer 120 may be performed by various coating processes according to the related art, and does not depend on any certain method. A washing process may be performed on the resin layer 120 coated on the carbon fiber 110, but may also be omitted. In a case where the washing process is performed, it is preferable that the washing process is performed at a sub-ambient temperature (for example: 20° C. to 40° C.). Ina case where the washing process is performed at a low temperature of lower than 20° C., a crack may occur, and in a case where the washing process is performed at a high temperature of higher than 40° C., the metal plating layer stacked on the resin layer may be melted. Therefore, it is preferable that the washing process is performed in the above temperature range.

The metal plating layer 130 formed on the surface of the resin layer 120 coated on the carbon fiber 110 may be formed of one or more metals. More specifically, the metal plating layer 130 may be formed in a form in which first to n^{th} metal plating layers are stacked. That is, a second plating layer plated with a second metal is formed on a first metal plating layer plated with a first metal, and a third plating layer plated with a third metal is formed on the second plating layer. First to n^{th} metals may be the same as or different from each other and it is preferable that the adjacent metal plating layers are formed of different metals.

The conductive and flexible carbon fiber 100 may further include a bonding layer formed on the surface of the resin layer 120 to increase a bonding force between the metal plating layer 130 and the resin layer 120. This will be described below in more detail.

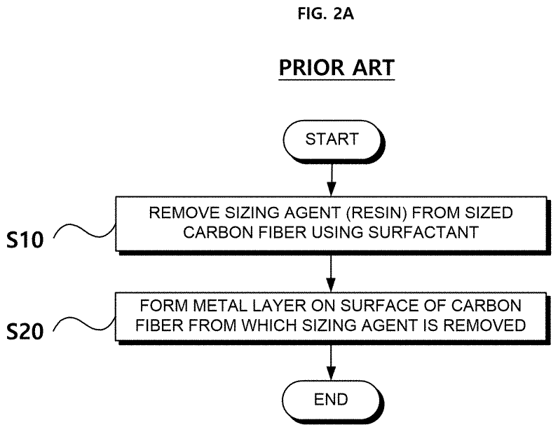

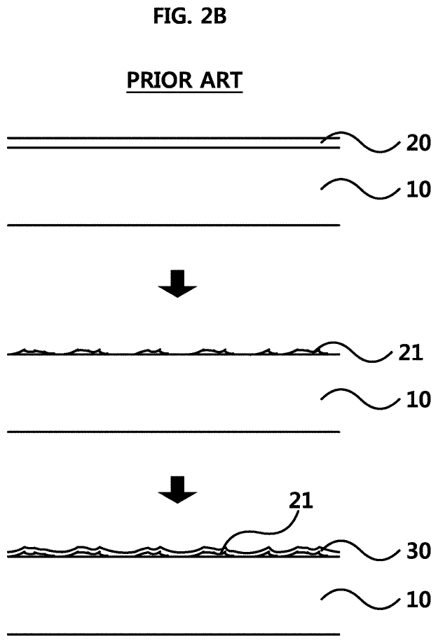

FIG. 2A illustrates a general production process of a conductive carbon fiber according to the related art. In the case of the conductive carbon fiber according to the related art, a resin (epoxy, urethane, and the like) sized on a carbon fiber is removed using a surfactant (S10). Next, a metal layer is formed on a surface of the carbon fiber from which a sizing agent is removed (S20), thereby producing a conductive carbon fiber according to the related art.

In such a production process, the surface of the metal layer becomes uneven. FIG. 2B illustrates a problem in the production process of the conductive fiber according to the related art. As illustrated in FIG. 2B, it is difficult to completely peel off the sizing agent even though the sizing agent on the surface of the carbon fiber is removed using a surfactant, and a residue 21 thus remains on the surface of the carbon fiber, such that the surface of the carbon fiber becomes very uneven. When a metal layer 30 is formed in this state, evenness of a surface of the metal layer 30 is also not ensured, which causes deterioration of electric conductivity and durability of the conductive carbon fiber.

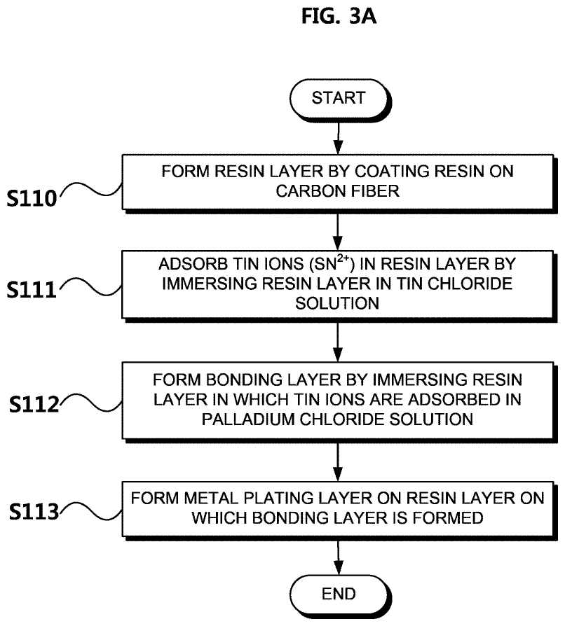

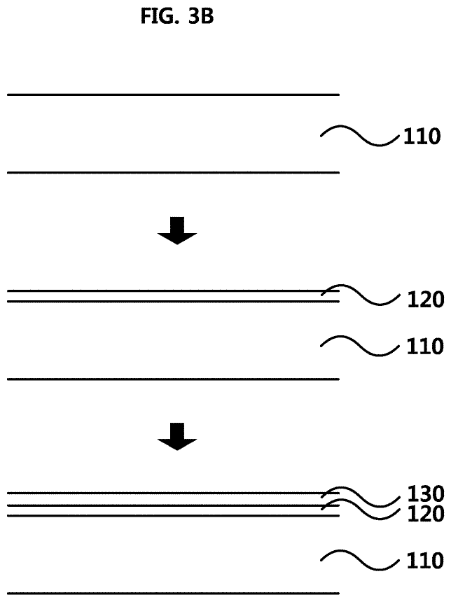

Contrary to the related art, as illustrated in FIG. 3A, in the conductive and flexible carbon fiber 100 according to the present disclosure, the resin layer is formed by coating a pure carbon fiber that is not subjected to any treatment with a resin (S110).

Next, tin ions (Sn²⁺) are adsorbed in the resin layer (S111), and then the resin layer is immersed in a palladium chloride (PdCl₂) solution, thereby forming a bonding layer (S112).

Lastly, a metal plating layer is formed on the resin layer on which the bonding layer is formed, such that the conductive and flexible carbon fiber 100 according to the present disclosure may be produced.

The conductive and flexible carbon fiber 100 according to the present disclosure produced by the production process of FIG. 3A has a very even surface. FIG. 3B illustrates surface evenness of the conductive and flexible carbon fiber 100 according to the present disclosure.

As illustrated in FIG. 3B, the resin layer 120 is very evenly coated on the pure carbon fiber 110 and the metal plating layer 130 is formed on the resin layer 120, such that the conductive and flexible carbon fiber 100 may have a smooth surface layer, thereby not only improving electric conductivity and durability but also securing flexibility due to the coating of the resin layer 120.

In addition, by only omitting a general process of removing the sizing agent according to the related art, the conductive and flexible carbon fiber 100 according to the present disclosure may realize cost and time savings in the production process.

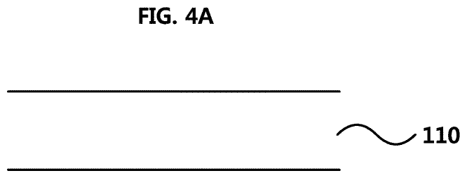

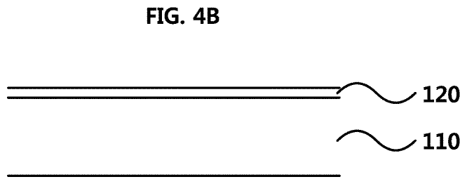

Hereinafter, the production process of the conductive and flexible carbon fiber 100 according to the present disclosure will be described. As illustrated in FIGS. 4A and 4B, the resin layer 120 is coated on a surface of the non-treated pure carbon fiber 110. By coating the resin layer 120, not only a breakage of the carbon fiber may be prevented but also flexibility of the carbon fiber may be secured during metal plating. It is preferable that the coating of the resin layer 120 is performed evenly over the entire surface of the carbon fiber 110.

A process of adsorbing tin ions (Sn²⁺) and a process of forming a bonding layer 125 are performed on the carbon fiber 110 on which the resin layer 120 is evenly coated.

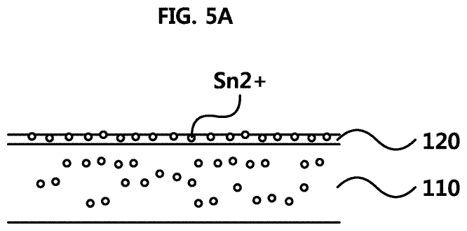

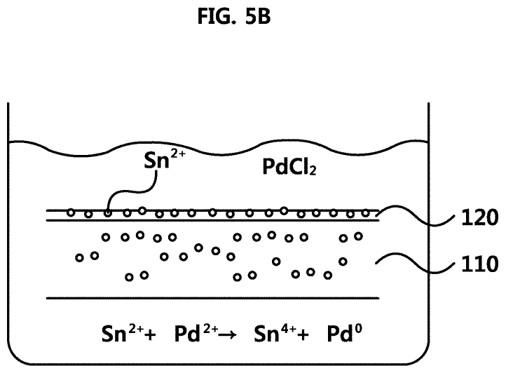

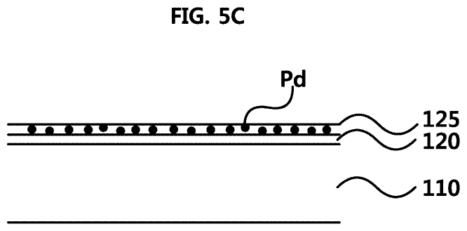

FIGS. 5A to 5C illustrate a process of forming a bonding layer of the conductive and flexible carbon fiber according to the present disclosure. As illustrated in FIGS. 5A to 5C, the tin ions (Sn²⁺) are first adsorbed in the resin layer 120 coated on the carbon fiber 110.

The adsorption of the tin ions (Sn²⁺) is performed by immersing the carbon fiber 110 on which the resin layer 120 is stacked in a tin chloride (SnCl₂) solution. Tin (Sn) may be adsorbed on the surface of the resin layer in a Sn²⁺ ion state. Since tin (Sn) has very excellent affinity with a carbon fiber, tin (Sn) may be adsorbed on the surface of the carbon fiber and to the inside of the carbon fiber. FIG. 5A illustrates the tin ions Sn²⁺ adsorbed on the surface (the surface of the resin layer) of the carbon fiber and to the inside the carbon fiber.

Compared with the related art, the resin layer 120 is coated on the surface of the carbon fiber 110 and has a hydrophobic surface by being subjected to a basic treatment, such that the tin chloride (SnCl₂) solution remaining after the tin ions (Sn²⁺) are adsorbed may be quickly removed.

It is also preferable that the process of adsorbing tin ions illustrated in FIG. 5A is performed at a sub-ambient temperature (for example: 20° C. to 40° C.) and the process may be repeated several times, rather than just once.

The carbon fiber 110 having the resin layer 120 in which the tin ions (Sn²⁺) are adsorbed may be immersed in a palladium chloride (PdCl₂) solution as illustrated in FIG. 5B. In this case, the palladium chloride (PdCl₂) solution may be replaced with a hydrochloric acid solution.

Palladium ions (Pd²⁺) in the palladium chloride (PdCl₂) solution react with the adsorbed tin ions (Sn²⁺) and are reduced to palladium (Pd⁰), and then the palladium (Pd⁰) is adsorbed on the surface of the resin layer 120, such that the bonding layer 125 is formed on the surface of the resin layer 120. FIG. 5C illustrates the bonding layer 125 formed on the resin layer 120.

It is also preferable that the process of forming a bonding layer 125 illustrated in FIG. 5B is performed at a sub-ambient temperature (for example: 20° C. to 40° C.) and the process may be repeated several times, rather than just once.

It is preferable that the process of adsorbing tin ions (Sn²⁺) and the process of forming a bonding layer 125 are sequentially performed. Specifically, it is preferable that the process of forming a bonding layer 125 is performed in a state where the process of adsorbing tin ions (Sn²⁺) is already performed.

In a case where the process of adsorbing tin ions (Sn²⁺) and the process of forming a bonding layer 125 are performed at the same time, tin ions (Sn²⁺), the palladium ions (Pd²⁺), and chlorine ions (Cl⁻) included in the treatment solution form a SnPdCl₄ compound, which causes a difficulty in adjusting a concentration of the chlorine ions (Cl⁻). In order to prevent this problem, both the processes are sequentially performed.

Further, a concentration of chlorine ions (Cl⁻) in the palladium chloride (PdCl₂) solution or the hydrochloric acid solution may affect a degree of evenness and a thickness of the metal plating layer to be formed by a subsequent plating process . Specifically, the concentration of the chlorine ions (Cl⁻) in the palladium chloride solution or the hydrochloric acid solution may be 13 to 17 mole/l, and preferably more than 13 mole/l and 16 mole/l or less . In a case where the concentration of the chlorine ions (Cl⁻) is less than 13 mole/l, a covalent bond between the a carbon atom (C) and palladium (Pd) on the surface of the carbon fiber is broken to allow the plating not to be performed. On the other hand, in a case where the concentration of the chlorine ions (Cl⁻) is more than 17 mole/l, palladium (Pd) is stabilized not to be adsorbed in the carbon fiber.

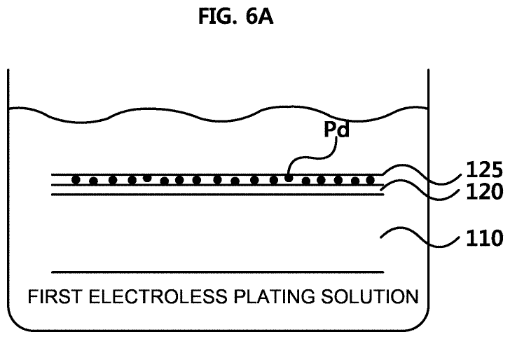

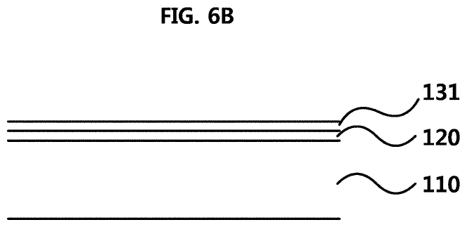

FIGS. 6A and 6B illustrate a process of forming a first metal plating layer 131 on the resin layer 120 on which the bonding layer 125 is formed. As illustrated in FIGS. 6A and 6B, the carbon fiber 110 having the resin layer 120 on which the bonding layer 125 formed of palladium (Pd) is formed is immersed in a first electroless plating solution. The first electroless plating solution includes pure water, a first metal salt, a complexing agent, a reducing agent, a stabilizer, and a pH adjusting agent.

More specifically, the first metal may be copper (Cu) and the first electroless plating solution may be formed of pure water, a copper metal salt, a complexing agent, a reducing agent, a stabilizer, and a pH adjusting agent.

Copper ions (Cu⁺) included in the first electroless plating solution forms the first metal plating layer 131 in a manner in which they react with the reducing agent included in the first electroless plating solution using palladium (Pd) constituting the bonding layer 125 as a catalyst to be reduced to copper (Cu) and then substitute for palladium (Pd) in the bonding layer 125.

A plating speed may be increased by such a copper plating method as compared with a copper plating method according to the related art. Specifically, a general copper plating is performed by a method in which a plating layer formed of strike type soft copper is formed, and then a thick hard copper plating layer is formed by autocatalytic plating of the plated copper (Cu) . In a case of the copper plating layer formed by the method according to the related art, a plating speed is just 0.2 to 0.5 μm/h. On the other hand, in a case of the copper plating layer of the present disclosure that is formed by performing the reduction using palladium (Pd) constituting the bonding layer 125 as a catalyst, a plating speed may be increased about 10 times (2 to 5 μm/h) as compared with the related art.

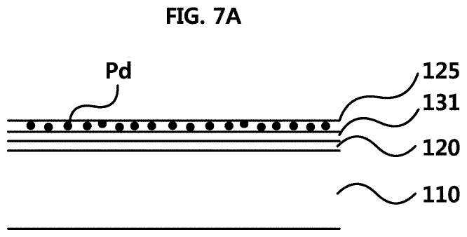

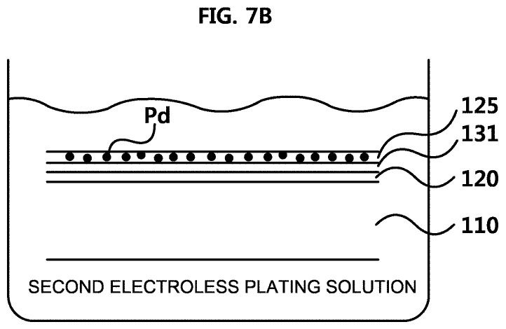

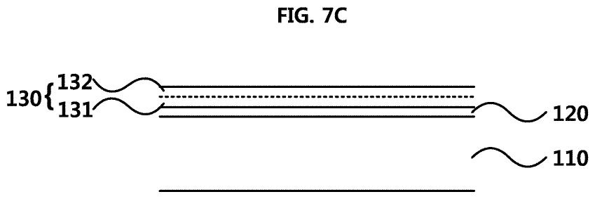

After copper (Cu) which is the first metal is plated on the resin layer 120, a second metal plating layer may be formed on the first metal plating layer. FIGS. 7A to 7C illustrate a process of forming a second metal plating layer 132 in the production of the conductive and flexible carbon fiber 100 according to the present disclosure.

First, in order to form the second metal plating layer, the bonding layer 125 formed of palladium (Pd) may be formed again on a surface of the first metal plating layer 131. Since a process of forming the bonding layer 125 may be performed by using the process described above, the description thereof will be omitted.

As illustrated in FIGS. 7A to 7C, the carbon fiber 110 having the first metal plating layer 131 on which the bonding layer 125 formed of palladium (Pd) is formed is immersed in a second electroless plating solution. The second electroless plating solution includes pure water, a second metal salt, a complexing agent, a reducing agent, a stabilizer, and a pH adjusting agent.

More specifically, the second metal maybe nickel (Ni), and the second electroless plating solution may be formed of pure water, a nickel metal salt, a complexing agent, a reducing agent, a stabilizer, and a pH adjusting agent.

Nickel ions (Ni⁺) included in the second electroless plating solution are plated on the first metal plating layer 131 in a manner in which they react with the reducing agent included in the second electroless plating solution using palladium (Pd) adsorbed in the first metal plating layer 131 and constituting the bonding layer 125 as a catalyst to be reduced to nickel (Ni) and then substitute for palladium (Pd) in the bonding layer 125 formed on the surface of the first metal plating layer 131.

By doing so, as illustrated in FIG. 7C, the conductive and flexible carbon fiber 100 including the metal plating layer 130 having a double layer structure and formed on the resin layer 120 may be produced.

Meanwhile, a process of washing the treatment solution and the plating solution that remain on the surface of the first and second metal plating layers 131 and 132 after the first and second metal plating layers 131 and 132 are formed may be further performed, and in this case, the washing process may be performed by wind dry at a sub-ambient temperature (for example: 20° C. to 40° C.).

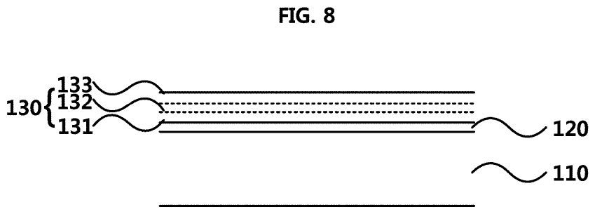

FIG. 8 illustrates a conductive and flexible carbon fiber 100 according to another exemplary embodiment of the present disclosure. As illustrated in FIG. 8, the conductive and flexible carbon fiber 100 according to the present disclosure may include a metal plating layer 130 including three or more layers . As described above, a third metal plating layer 133 may also be formed on a second metal plating layer 132 on which a bonding layer 125 formed of palladium (Pd) is formed. By doing so, a metal plating layer formed of various metals such as copper (Cu) and nickel (Ni) may be formed.

As compared with the conductive carbon fiber obtained by removing the sizing agent (resin) from the carbon fiber and then forming the metal layer on the carbon fiber according to the related art, the conductive and flexible carbon fiber 100 according to the present disclosure produced by the above method may realize an economic efficiency and significantly increase flexibility by coating the resin layer 120 on the carbon fiber 110. In addition, electric conductivity of the carbon fiber may be increased by forming the metal plating layer having a uniform thickness.

As compared with the conductive carbon fiber from which the sizing agent (resin) is removed according to the related art, the conductive and flexible carbon fiber 100 according to the present disclosure may have significantly increased electric conductivity.

Table 1 shows a comparison of electric conductivity of the conductive and flexible carbon fiber according to the present disclosure with electric conductivity of the conductive carbon fiber from which the resin layer is removed according to the related art.

TABLE 1

| | Resistance (Ω/m) | | |
|---|---|---|---|
| Type of carbon fiber | Average | St. Dev | Max-Min |
| Conductive carbon fiber | 3.37 | 0.73 | 4.5 |
| from which resin layer is | | | |
| removed according to the | | | |
| related art | | | |
| Conductive and flexible | 0.85 | 0.02 | 0.09 |
| carbon fiber according to | | | |
| the present disclosure | | | |

Electric conductivity means the inverse number of resistivity, and the lower resistivity means the higher electric conductivity. As shown in Table 1, the conductive carbon fiber obtained by removing the resin layer and then performing the metal plating according to the related art has an average resistance of 3.37 Ω/m, a standard deviation (St. Dev) of 0.73, and a difference of 4.5 Ω/m between the maximum resistance and the minimum resistance. Meanwhile, the conductive and flexible carbon fiber 100 according to the present disclosure has an average resistance of 0.85 Ω/m, a standard deviation (St. Dev) of 0.02, and a difference of 0.09 Ω/m between the maximum resistance and the minimum resistance. From the results, it is appreciated that the electric conductivity is significantly improved in the conductive and flexible carbon fiber 100 according to the present disclosure.

Table 2 shows distribution of the number of samples for each resistance range of the conductive carbon fiber from which the resin layer is removed according to the related art.

TABLE 2

| | Resistance range (Ω/m) | | | | |
|---|---|---|---|---|---|
| | 2.00 to | 2.70 to | 3.30 to | 4.00 to | More than |
| | 2.69 | 3.29 | 3.99 | 4.99 | 5.00 |
| The number of | 298 | 115 | 110 | 24 | 4 |
| samples for | | | | | |
| each range | | | | | |
| Percentage | 54% | 21% | 20% | 4% | 1% |

In addition, Table 3 shows distribution of the number of samples for each resistance range of the conductive and flexible carbon fiber 100 according to the present disclosure.

TABLE 3

Resistance range (Ω/m)

| | 0.800 to | 0.840 to | 0.870 to | 0.890 to |
|---|---|---|---|---|
| | 0.839 | 0.869 | 0.889 | 0.919 |
| The number of | 28 | 90 | 45 | 7 |
| samples for | | | | |
| each range | | | | |
| Percentage | 17% | 4% | 26% | 4% |

As shown in Table 2, the conductive carbon fiber according to the related art has a high resistance range of 2.00 Ω/m to 5.00 Ω/m. On the other hand, as shown in Table 3, the conductive and flexible carbon fiber 100 according to the present disclosure has a low resistance range of 0.800 Ω/m to 0.919 Ω/m, and in particular, it is appreciated that since the dispersion of the number of samples for each resistance range is low, the electric conductivity is significantly high.

Meanwhile, as compared to the conductive carbon fiber from which the sizing agent (resin) is removed according to the related art, the conductive and flexible carbon fiber 100 according to the present disclosure may realize a more uniform thickness of the metal plating layer.

Table 4 shows a comparison of thickness uniformity of the conductive and flexible carbon fiber according to the present disclosure with thickness uniformity of the conductive carbon fiber from which the resin layer is removed according to the related art.

TABLE 4

| | Plating thickness (μm) | | |
|---|---|---|---|
| Type | Average | St. Dev | Max-Min |
| Conductive carbon fiber | 456.8 | 37.6 | 87 |
| from which resin layer is | | | |
| removed according to the | | | |
| related art | | | |
| Conductive and flexible | 483.5 | 11 | 24 |
| carbon fiber according to | | | |
| the present disclosure | | | |

Referring to Table 4, it is appreciated that since the conductive and flexible carbon fiber 100 according to the present disclosure has a small standard deviation of the plating thickness and the difference between the maximum thickness and the minimum thickness of the conductive and flexible carbon fiber 100 according to the present disclosure is about 4 times smaller as compared with the conductive carbon fiber from which the resin layer is removed according to the related art, the thickness uniformity is significantly improved in the conductive and flexible carbon fiber 100 according to the present disclosure.

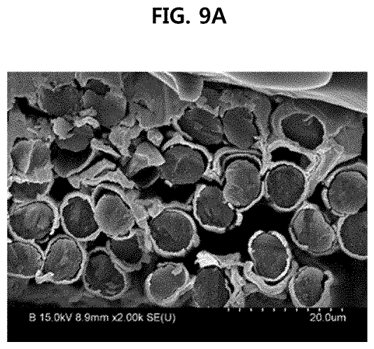

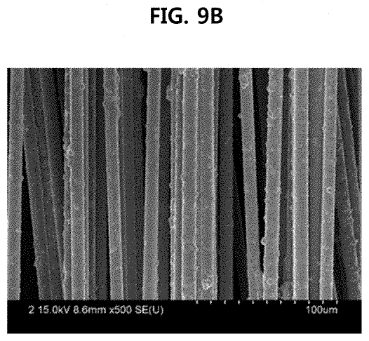

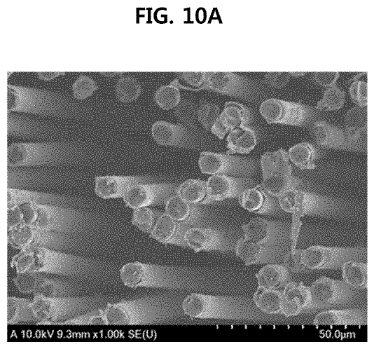

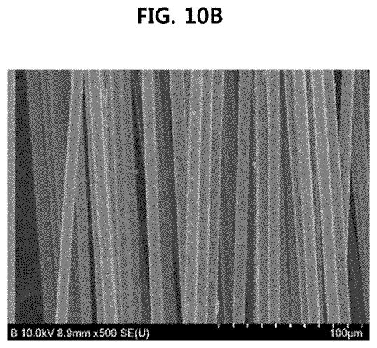

FIGS. 9A to 10B are photographs of comparing the thickness uniformity of the conductive and flexible carbon fiber according to the present disclosure with the thickness uniformity of the conductive carbon fiber from which the resin layer is removed according to the related art. Specifically, FIGS. 9A and 9B are photographs obtained by observing a conductive carbon fiber from which a resin layer is removed according to the related art with a microscope, and FIGS. 10A and 10B are photographs obtained by observing a conductive and flexible carbon fiber according to the present disclosure with a microscope.

FIG. 9A illustrates a cut surface of the conductive carbon fiber from which the resin layer is removed according to the related art, and FIG. 9B illustrates a surface state of the conductive carbon fiber from which the resin layer is removed according to the related art. As apparent from FIGS. 9A and 9B, since the resin layer is not completely removed and remains on the surface of the carbon fiber in a uneven state even though the resin layer is removed from the conductive carbon fiber according to the related art, when the metal plating is performed on the surface of the carbon fiber, the surface of the metal plating layer is not even and fuzzy is generated on strands of the carbon fiber. These problems cause deterioration of electric conductivity and poor processability such as a breakage of carbon plating.

FIG. 10A illustrates a cut surface of the conductive and flexible carbon fiber 100 according to the present disclosure, and FIG. 10B illustrates a surface state of the conductive and flexible carbon fiber 100 according to the present disclosure. In FIGS. 10A and 10B, it is appreciated that the surface of the carbon fiber is very smooth and the thickness of the metal plating layer is very uniformly formed as compared with FIGS. 9A and 9B. In the conductive and flexible carbon fiber 100 according to the present disclosure, the resin layer 120 is uniformly coated at a thickness of 10 nm, the bonding layer is formed, and then the bonding layer is converted into the metal plating layer by performing the metal plating on the bonding layer, such that the surface of the carbon fiber is smooth and the thickness of the metal plating layer is uniformly maintained as illustrated in FIGS. 10A and 10B, thereby achieving technical effect capable of improving electric conductivity. In addition, the problem such as a breakage of the carbon plating during processing may be prevented by coating of the resin layer.

Meanwhile, it was confirmed, through experiments, that the thickness of the resin layer 120 of the conductive and flexible carbon fiber 100 according to the present disclosure has a great influence on electric conductivity.

Table 5 shows the results of resistances obtained by changing a thickness of the resin layer 120 of the conductive and flexible carbon fiber 100 produced by the method described above. The experiments were performed by coating epoxy resin layers having different thicknesses of 10 nm to 5 μm on 3K carbon fibers and then measuring the resistance of each of the produced conductive and flexible carbon fibers. The minimum thickness of the resin layer is set to 10 nm in order to secure coating effects.

TABLE 5

| | Thickness of resin layer | | | | | |
|---|---|---|---|---|---|---|
| | 10 nm | 0.1 μm | 1 μm | 2 μm | 4 μm | 5 μm |
| Resistance (Ω/m) | 0.90 | 0.84 | 0.86 | 1.58 | 2.24 | 2.36 |

Referring to Table 5, it is appreciated that the thickness of the resin layer 120 has the critical meaning in a range of 10 nm to 1 μm in terms of electric conductivity. That is, it is appreciated that in a case where the thickness of the resin layer 120 is 10 nm to 1 μm, the resistance of the conductive and flexible carbon fiber is 1 Ω/m or less, which is very low, whereas in a case where the thickness of the resin layer 120 exceeds 1 μm, the resistance of the conductive and flexible carbon fiber is 1.5 Ω/m, which causes a small increase rate of the electric conductivity. Needless to say, the conductive and flexible carbon fiber has excellent electric conductivity within all the ranges as compared with the resistance of the carbon fiber from which the resin layer is removed according to the related art . However, in a case where the thickness of the resin layer 120 is adjusted in the range of 10 nm to 1 μm, the more improved electric conductivity may be secured. The difference in electric conductivity depending on the thickness of the resin layer 120 may be compared through the photographs obtained by the microscope with the naked eyes.

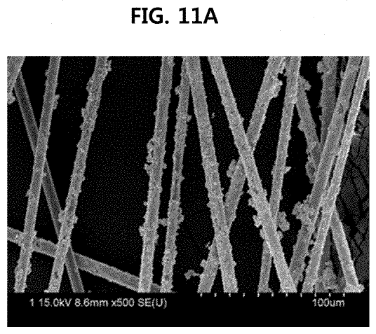

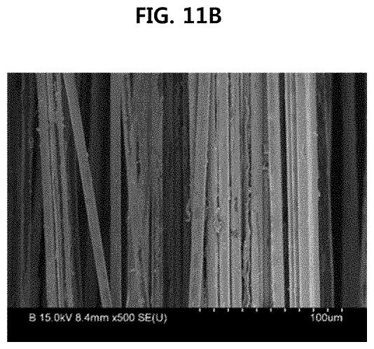

FIGS. 11A and 11B are photographs obtained by observing a carbon fiber having a resin layer whose thickness is greater than 1 μm with a microscope. It can be seen that the surface of the carbon fiber is somewhat roughened as compared with the resin layer 120 having the thickness of 10 nm of the conductive and flexible carbon fiber 100 illustrated in FIGS. 10A and 10B.

It is appreciated that in the case where the thickness of the resin layer 120 exceeds 1 μm, flexibility of the carbon fiber is reduced, such that a crack occurs when the carbon fiber is wound around a paper tube. Accordingly, the non-uniformity of resistance of the carbon fiber may be increased.

Therefore, it is preferable that the thickness of the resin layer 120 of the conductive and flexible carbon fiber 100 according to the present disclosure is 10 nm to 1 μm.

The resin layer of the carbon and flexible carbon fiber according to the present disclosure has the resin layer uniformly coated on the carbon fiber, such that a breakage of the carbon fiber during the conductive carbon fiber production process may be prevented. In addition, the metal plating layer having the uniform thickness is plated on the resin layer having the uniform thickness, such that the electric conductivity of the carbon fiber may be improved and the flexibility of the carbon fiber may also be increased. In addition, a production process of the carbon and flexible carbon fiber according to the present disclosure is simplified, such that the production cost and time may be saved.

Although the exemplary embodiments of the present disclosure has been described with reference to the accompanying drawings, those skilled in the art will appreciate that various modifications and alterations may be made without departing from the spirit or essential feature of the present disclosure. Therefore, it should be understood that the aforementioned exemplary embodiments are illustrative in terms of all aspects and are not limited.

What is claimed is:

1. A conductive and flexible carbon fiber, comprising:
a carbon fiber;
a resin layer formed on the carbon fiber; and
a metal plating layer formed on the resin layer.

2. The conductive and flexible carbon fiber of claim 1, wherein a thickness of the resin layer is 10 nm to 1 μm.

3. The conductive and flexible carbon fiber of claim 1, further comprising a bonding layer to increase a bonding force between the resin layer and the metal plating layer.

4. The conductive and flexible carbon fiber of claim 3, wherein the bonding layer is formed on the resin layer by immersing the resin layer in which tin ions (Sn²⁺) are adsorbed in a palladium chloride (PdCl₂) solution or a hydrochloric acid solution, and
a concentration of chlorine ions (Cl⁻) in the palladium chloride (PdCl₂) solution or the hydrochloric acid solution is 13 to 16 mole/l.

5. The conductive and flexible carbon fiber of claim 3, wherein the bonding layer is formed of palladium (Pd).

6. The conductive and flexible carbon fiber of claim 1, wherein the resin layer coated on the carbon fiber is non-conductive and has a hydrophobic surface.
